(19) United States
(12) Patent Application Publication
(10) Pub. No.: US 2010/0149573 A1
(43) Pub. Date: Jun. 17, 2010

(54) SYSTEM AND METHOD OF PROVIDING IMAGE FORMING MACHINE POWER UP STATUS INFORMATION

(75) Inventors: Andrew Colin Pat, Stevenage (GB); Michael Peter Golding, Ware (GB)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/336,699

(22) Filed: Dec. 17, 2008

(51) Int. Cl. G06F 3/12

(52) U.S. Cl. 358/1.13

(57) ABSTRACT

A printed image forming machine capable of forming a printed image on an output sheet is disclosed. The machine undergoes a power up process moving from a low power consuming mode to a higher power consuming mode in which it is ready to operate. The image forming machine includes a display, and a controller for displaying a sequence of images of an animated character having eyes in the process of waking up from sleep, the sequence corresponding to stages of a power-up process of the printed image forming machine for providing a visual indication of the status of the machine.

### BACKGROUND

Disclosed in embodiments herein are methods and systems for providing machine status information to a User, and more particularly to providing a pleasing visual indication of the machine's power up status using a sequence of images of an animated character waking up from sleep.

Printed image forming machines, including copy machines and/or printers etc., include components which can consume a large percentage of the energy used by the machine. For example, solid ink printing machines heat phase change ink into liquid form for printing. Xerographic machines include heated fusers for bonding toner to paper, etc. for forming printed images.

Keeping these components fully powered up and ready for immediate operation during periods of machine inactivity can waste energy. In an effort to save energy, these machines can be placed into low power modes using less energy.

However, a machine placed in an energy saving mode is not available to immediately perform a marking or printing operation, such as printing or copying. The machine has to undergo a power up process which can take some time. Therefore, a User instructing the machine to proceed with a copying or printing job will have to wait for the power up process to be completed before the machine performs the task leading to frustration and impatience.

It is desirable to alleviate a User's impatience while waiting for the completion of a power up process while providing useful information of the machine's status. The present systems and methods described herein address these problems and others by providing a useful and pleasant distraction for a User waiting to operate a printed image forming machine.

### BRIEF DESCRIPTION

A system and method of providing a visual indication of the status of a printed image forming machine progressing through a power up process is provided.

In one aspect, a printing machine is disclosed having a display and a controller in operational communication with the display providing a sequence of images on the display of an animated character having eyes in the process of waking up from sleep, the sequence corresponding to stages of a power-up process of the printing machine.

In another aspect, a method is disclosed for providing power-up status information for a printed image forming machine having a user interface display including displaying on the display a sequence of images of an animated character having eyes in the process of waking up from sleep, the sequence corresponding to stages of a power-up process of the printing machine.

In another aspect of the method, the displaying includes displaying the character's eyes as fully closed representing the character as sleeping during an initial stage in the power-up process, displaying the character's eyes as partially open representing the character as waking from sleep during an intermediate stage in the power-up process, and displaying the character's eyes as fully open representing the character as fully awake during a final stage in the power-up process signifying the end of the power up process wherein the machine is ready for printing.

### BRIEF DESCRIPTION OF THE DRAWINGS

FIG. 1 is a block diagram of a multi-function printed image forming machine;

FIG. 2 is a block diagram illustrating different stages of a power up process for the printed image forming machine of FIG. 1;

FIG. 3 is a diagram illustrating a User Interface console having a display displaying an animated character;

FIG. 4 is a diagram illustrating the animated character as being asleep representing the machine as being in a low power mode;

FIG. 5 is a diagram illustrating the animated character as being initially awoken from sleep representing the machine as beginning a power up process;

FIG. 6 is a diagram illustrating the animated character as being partially awake representing the machine as being in an intermediate stage of a power up process;

FIG. 7 is a diagram illustrating the animated character as being awake representing the machine as being in a later intermediate stage of a power up process; and

FIG. 8 is diagram illustrating the animated character as being fully awake representing the machine as completing the power up process.

### DETAILED DESCRIPTION

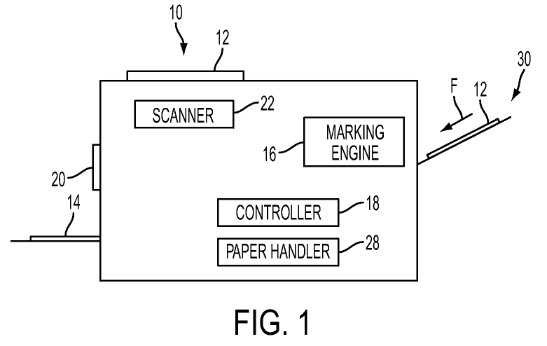

With reference to FIG. 1, an image forming machine is shown generally at 10. The image forming machine 10 can be capable of copying a physical original document sheet 12 and/or producing printed images on an output sheet 14 by utilizing a marking engine 16. The marking engine 16 can be a Xerographic engine, a solid ink print engine, an ink jet print engine, or any other known printing or copying engines for forming printed images. The process of forming the printed image can be referred to as marking, printing, copying, etc. Examples of suitable image forming machines 10 can include, but are not limited to, ink jet printers, copiers, printer/copiers, multifunction printing devices, solid ink printers, and the like.

The image forming machine 10 also includes a controller, also referred to as an electronic sub-system (ESS) 18, including one or several computational processing devices, such as computers or other electronic controlling devices capable of running programmed logic instructions and performing control operations for operating the image forming machine 10. The controller 18 uses input from sensors and timers to produce the printed output sheets 14 during printing/copying operations.

The image forming machine 10 also includes a console 20 typically located on an exterior surface of the machine, providing a User Interface (UI) to a User for operating the machine. The console 20 accepts inputs from the User for providing commands or instructions to the controller 18 for performing machine operations, such as start a copying job, how many copies to make, etc. The console also outputs information to the User on a display to query the User for more inputs, to provide status information, and to give other instructions if needed. The console 20 is operatively connected to the controller 18 in a known manner for controlling its operation in a manner as described herein.

The image forming machine 10 can also include a scanner, also referred to as an image input terminal (IIT) 22, for scanning images for capture and reproduction, such as during copying operations. The image forming machine 10 also includes a document handler 28 controlled by the controller 40 for moving the sheets 12 through the device, storing and providing the output sheets 14, or receiving them via external trays 30, and post processing the output sheets, such as stapling, sorting, etc.

The image forming machine 10 includes one or more energy saving modes in which the machine consumes less energy than it does when it is ready to run a marking operation, such as printing or copying. For example, the machine 10 can include ENERGY STAR® Power Management features controlled by controller 40, which place the machine into a low-power “sleep mode” after a period of inactivity.

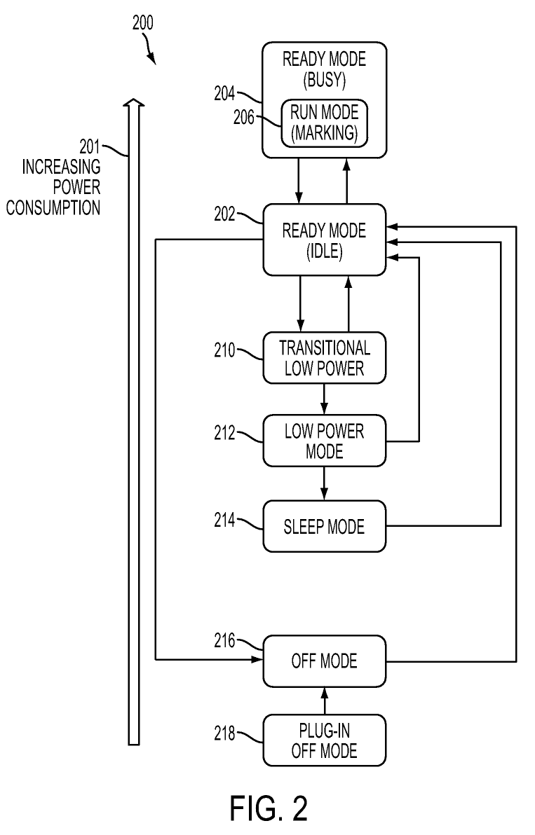

Referring now to FIG. 2, an example of a power saving strategy having several energy saving modes for the image forming machine 10 is shown generally at 200. It should be appreciated that this power saving strategy is provided by way of example and others may be contemplated.

The machine 10 includes a ready mode 202 in which it is ready to accept a command to run a print job. The machine is said to be ready in that it can, upon receiving the command or commands, proceed with running the print job without delay. In this ready mode 202, the machine can be considered to be idle in that it has not yet received a command instructing it to proceed, and it can therefore be called the ready-idle mode. The machine 10 consumes more power in the ready-idle mode 202 than it does in the low power modes described below, since the marking engine 16 has been made ready to proceed with forming a printed image, and it is kept ready in this powered-up status while the machine is in the ready-idle mode. To save energy, the controller 18 seeks to limit the amount of time the machine spends in the ready-idle mode before placing it into a low power/power saving mode. For example, one or more timers can be used to determine a predetermined length of inactivity thereby signaling for the controller to place the machine into a low power mode.

The power up process is illustrated which includes a printed image forming machine moving from a low power mode into a ready-idle mode 202. The controller can begin the power up process powering the machine up and into the ready-idle mode using a variety sensed indicators, such as for example a User pressing a button on the console 20, or turning the machine one with the ON/OFF switch, etc. The machine 10 can be considered to be powered-up, or to have reached the end of its power-up process when it is in the ready-idle mode 202.

The machine 10 also includes a ready mode in which it has received instructions to proceed with printing and therefore can be considered to be in a ready-busy mode 204. The ready-busy mode 204 is not a low power (power saving) mode, because the machine typically consumes more energy than it does in the ready-idle mode 202. From the ready-busy mode 204, the machine moves on to the run mode 206 during which it runs a print job forming one or more printed images. The machine typically consumes the most power in the run mode 206.

The machine 10 can include a plurality of low power modes. For example, the machine can include a transitional low power mode 210 for energy saving to meet technical compliance with predetermined energy usage requirements. The machine can include a low power mode 212 consuming less power than the transitional low power mode 210. In the low power mode, the machine typically consumes less energy by cutting power to the IIT and document handler. During the power up process, the machine can move from the low power mode 212 into the ready-idle mode 202.

The machine also includes a low power/power saving mode referred to as the sleep mode 214 in which the machine consumes less power than the low power 212, or transitional low power 210 modes. During the power up process, the machine can move from the sleep mode 216 into the ready-idle mode 202. The power up process in which the machine 10 moves from the sleep mode to the ready-idle mode can take 10 seconds to 60 seconds, or more.

The machine 10 can also include low power/power saving modes which include the off mode 216, in which the machine's ON/OFF switch is in the OFF position, and a plug-in off mode 218 in which the machine is first plugged into an AC outlet. The power-up process can include the machine moving from the off mode 216 to the ready-idle mode 202 a shown.

While a plurality of low power modes are shown by way of example, it should be appreciated that the machine may include fewer low power modes, and even a single low power mode, such as for example a sleep mode.

The controller 40 handles machine power management features which can place the machine in modes of operation, referred to as lower power modes, which consume less power than full ready mode wherein the machine is ready for printing and/or copying. The controller 40 can use timers to determine device inactivity, such as measuring the time accumulated since a button was pressed or an electronic command was received. Upon determining that the device is inactive, the controller can place the device in a lower power consuming mode. One or more of such timers can be used to put the device into successively lower power modes in dependence on the length of inactivity of the machine.

A machine placed in an energy saving mode is not available to immediately perform a marking operation, such as printing or copying. The machine has to undergo a power up process which can take up to 30 seconds or more. Therefore, a User instructing the machine to proceed with a copying or printing job via the console 40 will have to wait for the power up process to be completed before the machine performs the task.

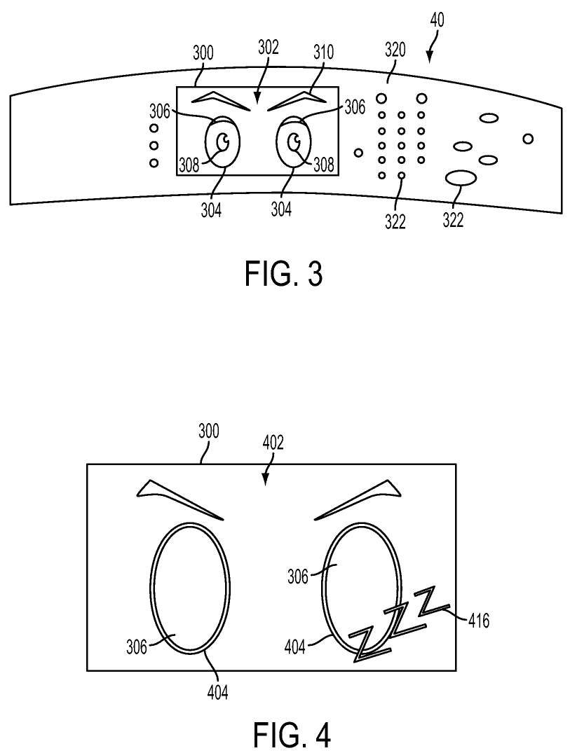

Referring now to FIG. 3, the machine's console 40 includes a display 300 providing visual information to the User for operating the machine. The display can be a touchscreen display, if so desired, to also collect information from the User when displayed buttons, etc. are pressed. The console 40 can also includes hardbuttons 322 for accepting User information/instructions on operating the machine, if so desired. The display 300 is operatively connected to the controller 40 for controlling what shown on the display.

A power up process can be started in a usual manner moving the machine from a low power mode, such as for example the sleep mode 214, into a higher power mode, such a for example the ready-idle mode 202. During this power up process, the machine display 300 shows a sequence of images of an animated character 302 in the process of waking up from sleep. The character 302 can include eyes 304 having eye lids 306 covering different portions of the eyes in a sequence of images to illustrate the character as waking up from sleep. The character's eyes 304 can include pupils 308 to provide lifelike characteristics to the animated character 302, if so desired. The character 302 can include eye brows 310 disposed above the eyes, which may move during the sequence to further enhance the character's lifelike characteristics.

Referring now to FIG. 4 the animated character 402 is shown with its eyes fully closed 404, that is fully covered by the eye lids 306, representing the character as being asleep in an initial stage of the power up process. The initial stage corresponds to a low power mode, such as for example the sleep mode 216. The character letter “ZZZ” can be displayed at 416 to enhance a User's understanding that the character 402 is asleep. Displaying the character 302 as being asleep in this manner can provide the User with a whimsical visual indication of the machine's status in the power up process, that of being in a sleep mode 214.

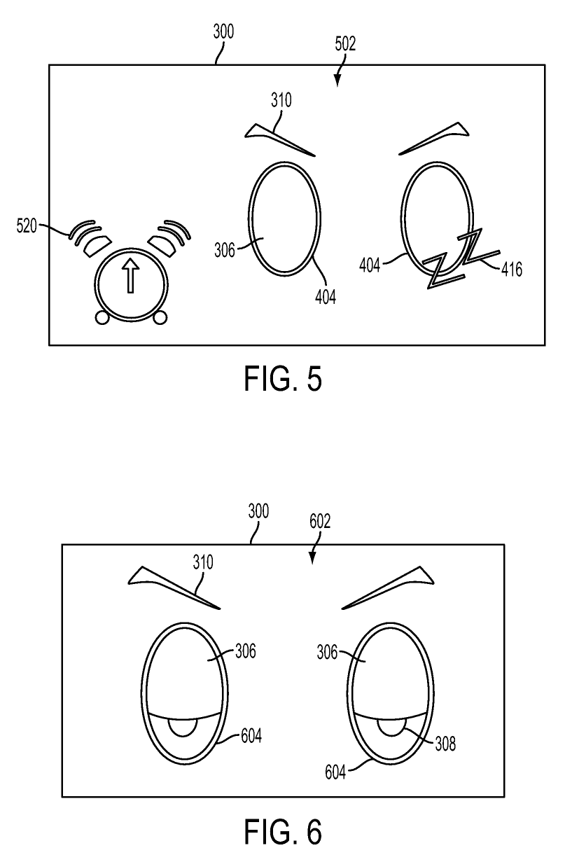

Referring now to FIG. 5 the character is shown as being initially awoken from sleep at 502. The character's eyes are fully closed at 404 showing the character as sleeping and being woken. Other animated features can be provided, such as for example an animated alarm clock ringing as shown at 520 and fewer “ZZ” shown at 506 than used for uninterrupted sleep at 406. This character 502 can be shown when the power up process is initiated by the controller 18, such as for example when a User first presses a button 322 on the consol. The controller 18 receives an indication that a console button 322 has been pressed and determines that the machine 10 is currently in a sleep mode and initiates the power up process.

Referring now to FIG. 6 the character is shown as beginning to wake up at 602 by displaying the character's eyes as partially open at 604. The eyes can be considered as partially open when the eye lids cover some to most of the eyes as shown. The character's eyes can blink to enhance the User's understanding that it is in an intermediate stage of waking from sleep as well as provide a more lifelike representation.

The character beginning to awaken 604 can be shown during an intermediate stage in the power up process to visually represent the status of the machine as being in an intermediate stage of the power up process. This intermediate stage can correspond to a power mode between the low power (sleep) mode and the ready mode at the end of the power up process. Alternatively, it can be displayed at a specific time during the intermediate stages of power up process to illustrate the machine as progressing towards the powered up, or full power, ready mode.

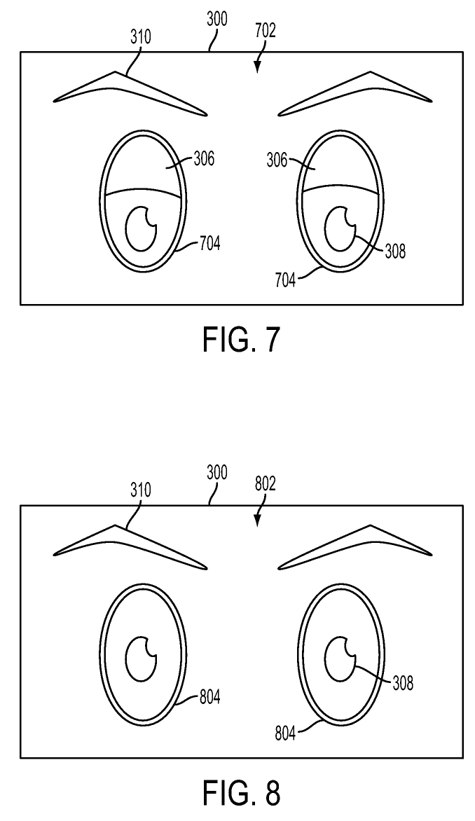

Referring now to FIG. 7 the character is shown as continuing to wake up at 702 by displaying the character's eyes as mostly open at 704. The eyes can be considered as mostly open 704, or only partially closed, when the eye lids 306 cover only some of the eyes, such as less than half, as shown. The character continuing to awaken 704 can be shown during a later intermediate stage in the power up process to visually represent the status of the machine as being in a later intermediate stage of the power up process corresponding to a power mode between the intermediate low power mode and the ready mode at the end of the power up process. Alternatively, it can be displayed at a specific time after showing the character as beginning to awaken at 604 to illustrate the machine as progressing towards the powered up, or full power, ready mode.

Referring now to FIG. 8 the character is shown as being fully awake at 802 by displaying the character's eyes as fully open at 804. The eyes can be considered as fully open 704 when the eye lids 306 cover the smallest portion of the eyes, or alternatively when the eye lids are no longer shown. The fully awake character 804 is shown when the machine reaches the end of the power up process, such as for example when it enters the ready-idle mode 202 to visually represent this status of the machine.

The sequence of images showing the animated character in the process of waking up from sleep, including ones showing its eyes fully closed representing it as asleep, ones showing its eyes as partially open representing it as waking, and ones showing its eyes as fully open representing it as awake, can each correspond to a different stage the machine goes through during the power up process. These different stages can correspond to different time periods during the power up process, or different power modes the machine may go through while powering up. The different stages can correspond to different physical conditions of the printed image forming machine during the power-up process, such as for example, different fuser temperature ranges, or different drum temperature ranges, or different ink temperature ranges, different ink melter temperature ranges. One or more of the physical conditions represented by a stage in the power up process can also include a scanner calibration stage, and a head alignment stage, among others.

The system and method described herein of displaying a sequence of images of an animated character having eyes in the process of waking up from sleep corresponding to the machine moving from a low power state to a high power ready mode provides a pleasing distraction for the User as he or she waits for the machine to complete a power up process. It also provides providing useful visual indication of the status of the machine as it progresses through the power up process and reaches a ready state, wherein it can begin to print and/or copy. The animated character can endear the User to the machine by imparting human or other lifelike characteristics. They can amuse the User and improve one's patience while waiting for the machine to power up for use.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of providing power-up status information for a printed image forming machine having a user interface display comprising:
displaying on the display a sequence of images of an animated character having eyes in the process of waking up from sleep, the sequence corresponding to stages of a power-up process of the printing machine.

2. The method of claim 1 wherein the displaying further comprises:
displaying the character's eyes as fully closed representing the character as sleeping during an initial stage in the power-up process;
displaying the character's eyes as partially open representing the character as waking from sleep during an intermediate stage in the power-up process; and
displaying the character's eyes as fully open representing the character as fully awake during a final stage in the power-up process.

3. The method of claim 1 wherein the displaying further comprises:
displaying the character's eyes as blinking representing the character as waking from sleep corresponding to an intermediate stage in the power-up process.

4. The method of claim 1 wherein the stages are time periods.

5. The method of claim 1 wherein the stages correspond to different physical conditions of the printing machine during the power-up process.

6. The method of claim 1 wherein the machine is a xerographic printing machine having a fuser increasing in temperature during the power-up process and the stages correspond to different fuser temperature ranges.

7. The method of claim 1 wherein the printing machine is an ink jet printing machine having a drum increasing in temperature during the power-up process and the stages correspond to different drum temperature ranges.

8. The method of claim 1 wherein the printing machine is an ink jet printing machine having phase-change ink increasing in temperature during the power-up process and the stages correspond to different ink temperature ranges.

9. A printed image forming machine comprising:
a display; and
a controller in operational communication with the display providing a sequence of images on the display of an animated character having eyes in the process of waking up from sleep, the sequence corresponding to stages of a power-up process of the printing machine.

10. The printed image forming machine of claim 9 wherein the sequence comprises displaying the character's eyes as fully closed representing the character as sleeping corresponding to an initial stage in the power-up process, displaying the character's eyes as partially open representing the character as waking from sleep corresponding to an intermediate stage in the power-up process, and displaying the character's eyes as fully open representing the character as fully awake corresponding to a final stage in the power-up process.

11. The printed image forming machine of claim 9 wherein the sequence further comprises displaying the character's eyes as blinking representing the character as waking from sleep corresponding to an intermediate stage in the power-up process.

12. The printed image forming machine of claim 9 wherein the stages are time periods.

13. The printed image forming machine of claim 9 wherein the stages correspond to different physical conditions of the printed image forming machine during the power-up process.

14. The printed image forming machine of claim 9 wherein the printed image forming machine is a xerographic printed image forming machine further comprising a fuser increasing in temperature during the power-up process and the stages correspond to different fuser temperature ranges.

15. The printed image forming machine of claim 9 wherein the printed image forming machine is an ink jet printed image forming machine further comprising a drum increasing in temperature during the power-up process and the stages correspond to different drum temperature ranges.

16. The printed image forming machine of claim 9 wherein the printed image forming machine is an ink jet printed image forming machine further comprising phase-change ink increasing in temperature during the power-up process and the stages correspond to different ink temperature ranges.
